(19) United States
(12) Patent Application Publication
(10) Pub. No.: US 2023/0383954 A1
(43) Pub. Date: Nov. 30, 2023

(54) Remote Stove Lock Assembly

(71) Applicant: John Nobles, Philadelphia, PA (US)

(72) Inventor: John Nobles, Philadelphia, PA (US)

(21) Appl. No.: 17/752,499

(22) Filed: May 24, 2022

(51) Int. Cl. F24C 7/08; G06V 40/13

(52) U.S. Cl. CPC F24C 7/082; G06V 40/13

(57) ABSTRACT

A remote stove lock assembly includes a stove that has a plurality of burner controls and a control unit that is attached to the stove. The control unit has a biometric scanner to scan an authorized user's fingerprint and the control unit enables each of the burner controls when the biometric scanner scans the authorized user's fingerprint thereby facilitating the stove to be employed for cooking. Conversely, the control unit disables each of the burner controls until the biometric scanner scans the authorized user's fingerprint to inhibit a person with dementia from operating the stove. A personal electronic device is in remote communication with the control unit to enable each of the burner controls when the personal electronic device broadcasts an actuate command to facilitate the authorized user to remotely enable or disable the stove.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to stove lock devices and more particularly pertains to a new stove lock device for inhibiting a stove from being employed for cooking. The device includes a stove with a plurality of burner controls and a control unit attached to the stove. The control unit has a biometric scanner for scanning an authorized user's fingerprint and a keypad for entering a numeric code. Each of the burner controls is actuated when an authorized fingerprint is scanned or a pre-determined code is entered. The device includes a personal electronic device that is in remote communication with the control unit to remotely enable or disable the burner controls.

### (2) Description of Related Art Including Information Disclosed Under 37 CFR 1.97 and 1.98

The prior art relates to stove lock devices including a password safety lock system for a cooking oven which includes an electronic keypad. The prior art discloses a gas safety valve for a stove that includes a key for unlocking the gas safely valve. The prior art discloses a kitchen appliance and a fingerprint scanner integrated into the kitchen appliance. The prior art discloses a stove safety device that includes sensors for sensing an alert agent to shut down the stove in the presence of the alert agent. The prior art discloses a kitchen appliance which includes a temperature sensor for shutting down the kitchen appliance for fire prevention. The prior art discloses a gas control device which includes a gas shutoff valve and a keypad for entering a numeric code to turn gas supply to a stove.

### BRIEF SUMMARY OF THE INVENTION

An embodiment of the disclosure meets the needs presented above by generally comprising a stove that has a plurality of burner controls and a control unit that is attached to the stove. The control unit has a biometric scanner to scan an authorized user's fingerprint and the control unit enables each of the burner controls when the biometric scanner scans the authorized user's fingerprint thereby facilitating the stove to be employed for cooking. Conversely, the control unit disables each of the burner controls until the biometric scanner scans the authorized user's fingerprint to inhibit a person with dementia from operating the stove. A personal electronic device is in remote communication with the control unit to enable each of the burner controls when the personal electronic device broadcasts an actuate command to facilitate the authorized user to remotely enable or disable the stove.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a remote stove lock assembly according to an embodiment of the disclosure.

FIG. 2 is a front view of an embodiment of the disclosure.

FIG. 3 is a logic tree view of an embodiment of the disclosure.

FIG. 4 is a perspective in-use view of an embodiment of the disclosure.

FIG. 5 is a schematic view of an embodiment of the disclosure.

### DETAILED DESCRIPTION OF THE INVENTION

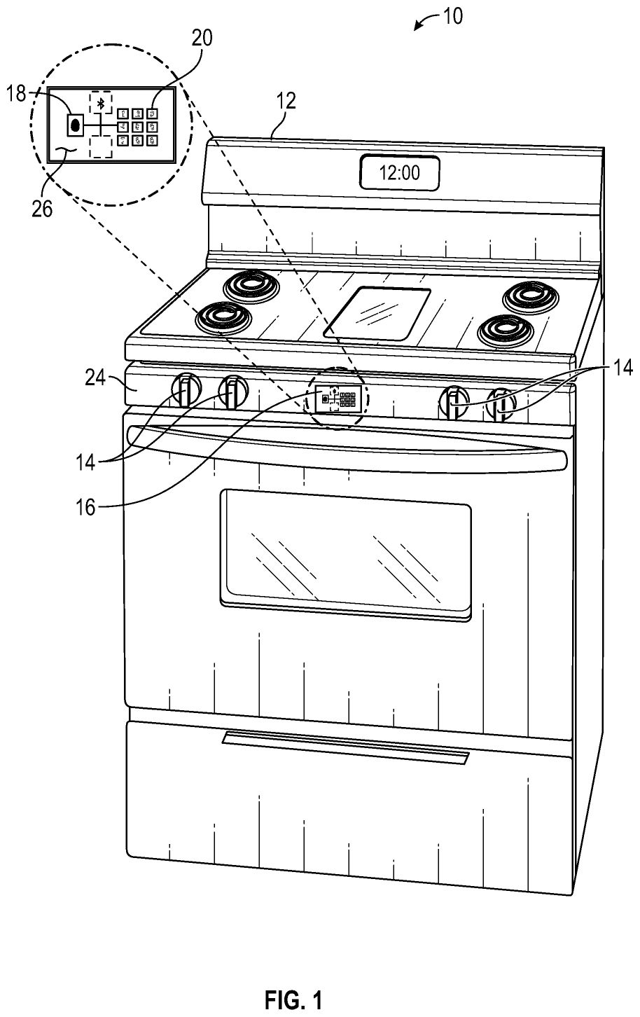

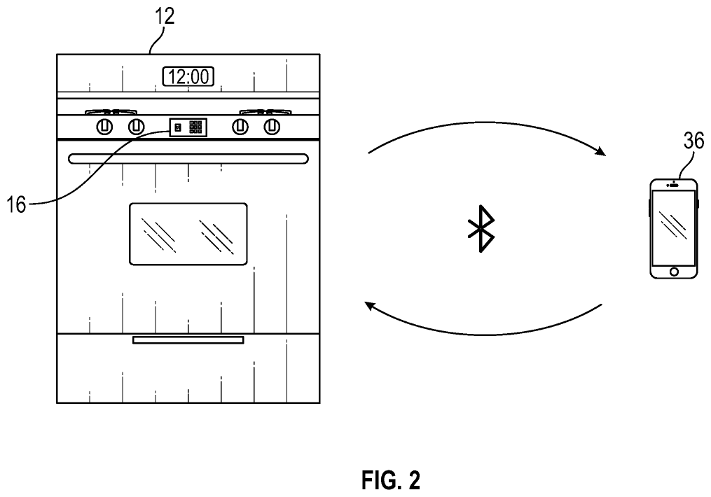

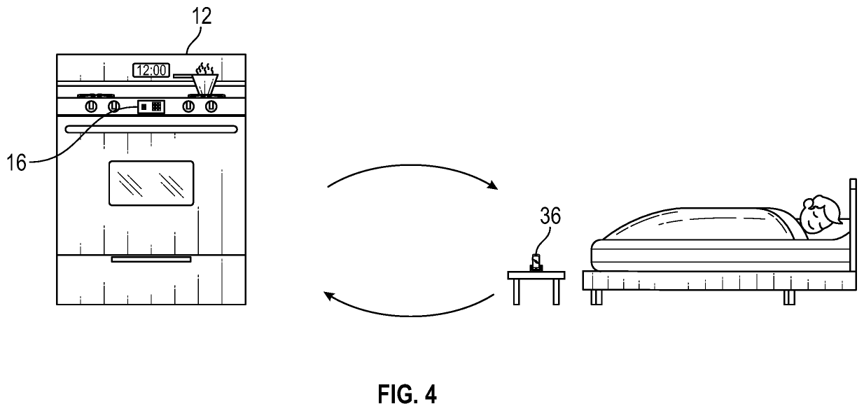

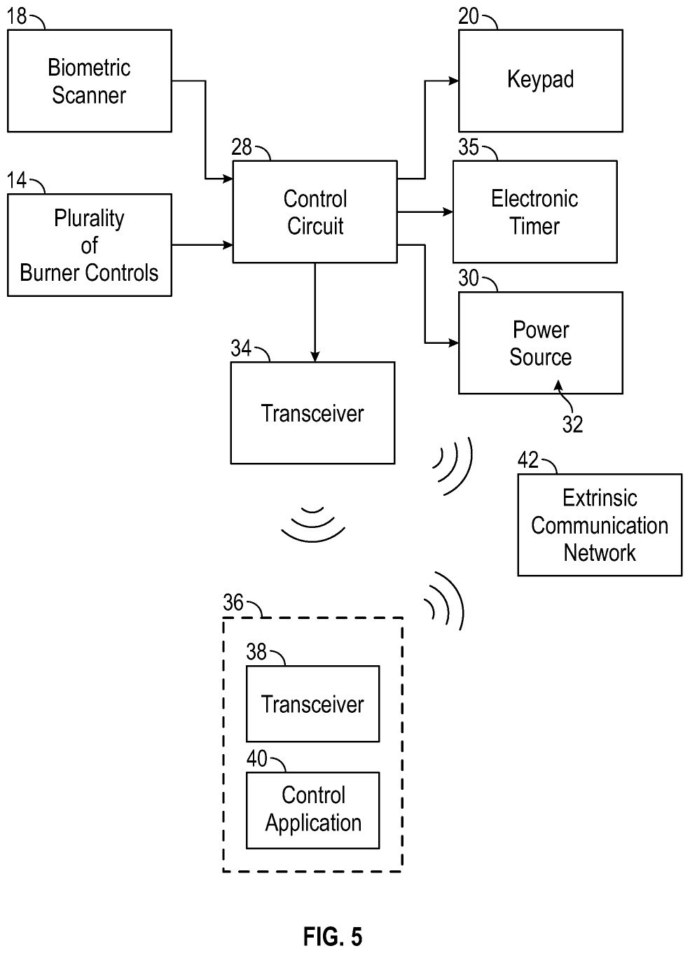

With reference now to the drawings, and in particular to FIGS. 1 through 5 thereof, a new stove lock device embodying the principles and concepts of an embodiment of the disclosure and generally designated by the reference numeral 10 will be described.

As best illustrated in FIGS. 1 through 5, the remote stove lock assembly 10 generally comprises a stove 12 that has a plurality of burner controls 14. The stove 12 may be an electric stove, a gas stove or any other type of cooking stove that might be found in residential kitchen. Each of the burner controls 14 may include an electronic control that turns on an electric burner or and electronic valve that facilitates or restricts a flow of fuel to a gas burner. Furthermore, each of the burner controls 14 can be electronically controlled to be actuated into either an enabled condition or a disabled condition. In way a burner knob on the stove 12, for example, has no effect on the burners on the stove 12.

A control unit 16 is attached to the stove 12 and the control unit 16 that is in communication with each of the burner controls 14. The control unit 16 has a biometric scanner 18 thereby facilitating the biometric scanner 18 to scan an authorized user's fingerprint. The control unit 16 enables each of the burner controls 14 when the biometric scanner 18 scans the authorized user's fingerprint thereby facilitating the stove 12 to be employed for cooking. The control unit 16 disables each of the burner controls 14 until the biometric scanner 18 scans the authorized user's fingerprint thereby inhibiting the stove 12 from being employed for cooking. In this way the control unit 16 inhibits a person with dementia from operating the stove 12.

The control unit 16 has a keypad 20 for facilitating a predetermined numeric code to be entered into the control unit 16. The control unit 16 enables each of the burner controls 14 when the predetermined numeric code is entered into the control unit 16. The control unit 16 comprises a housing 22 that is positioned on a front face 24 of the stove 12 and the housing 22 has a front surface 26 that is exposed with respect to the front face 24. The biometric scanner 18 is positioned on the front surface 26, the keypad 20 is positioned on the front surface 26 and the keypad 20 comprises a plurality of alphanumeric keys.

The control unit 16 includes a control circuit 28 that is integrated into the housing 22 and the control circuit 28 is electrically coupled to each of the burner controls 14. Each of the burner controls 14 is normally actuated into a disabled condition such that the stove 12 is inhibited from is employed for cooking. The control circuit 28 receives an actuate input and each of the burner controls 14 is actuated into an enabled condition when the control circuit 28 receives the actuate input thereby facilitating the stove 12 to be employed for cooking. The control circuit 28 is electrically coupled to the biometric scanner 18 and the control circuit 28 is electrically coupled to the keypad 20. The control circuit 28 receives the actuate input when the biometric scanner 18 scans the authorized user's fingerprint and the control circuit 28 receives the actuate input when the predetermined numeric code is entered into the keypad 20. Additionally, the control circuit 28 is electrically coupled to a power source 30 comprising a power supply 32 of the stove 12.

A transceiver 34 is integrated into the housing 22, the transceiver 34 is electrically coupled to the control circuit 28 and the transceiver 34 may comprise a radio frequency transceiver or the like. The control circuit 28 includes an electronic timer 35 which begins a countdown when the control circuit 28 receives the actuate input. The countdown may be a duration of time of at least 10.0 minutes and the control circuit 28 receives a de-actuate input when the electronic timer 35 completes the countdown and none of the burner controls 14 has been turned on to cook with the stove 12. In this way the electronic timer 35 inhibits the burner controls 14 from remaining in the enabled condition when none of the burner controls 14 is turned on.

A personal electronic device 36 is carried by the authorized user and the personal electronic device 36 is in remote communication with the control unit 16. The control unit 16 enables each of the burner controls 14 when the personal electronic device 36 broadcasts an actuate command to the control unit 16. In this way the personal electronic device 36 facilitates the authorized user to remotely enable or disable the stove 12. The personal electronic device 36 includes a transceiver 38 and the transceiver 38 in the personal electronic device 36 is in wireless communication with the transceiver 34 of the control unit 16. Furthermore, the personal electronic device 36 stores a control application 40.

The control application 40 actuates the transceiver in the personal electronic device 36 to broadcast the actuate command to the transceiver 34 in the control unit 16 when the control application 40 is manipulated by the authorized user to perform an actuation subroutine. Furthermore, the control application 40 actuates the transceiver 38 in the personal electronic device 36 to broadcast a de-actuate command to the transceiver in the control unit 16 when the control application 40 is manipulated by the authorized user to perform a de-actuation subroutine. The control circuit 28 receives the de-actuate input when the transceiver 34 in the control unit 16 receives the de-actuate command such that each of the burner controls 14 is actuated into the disabled condition. The personal electronic device 36 may comprise a smart phone or other similar type of computerized device that has wireless communication capabilities. Furthermore, each of transceiver 34 in the control unit 16 and the transceiver 38 in the personal electronic device 36 may be in wireless communication with an extrinsic communication network 42, such as the internet for example, thereby facilitating long distance communication.

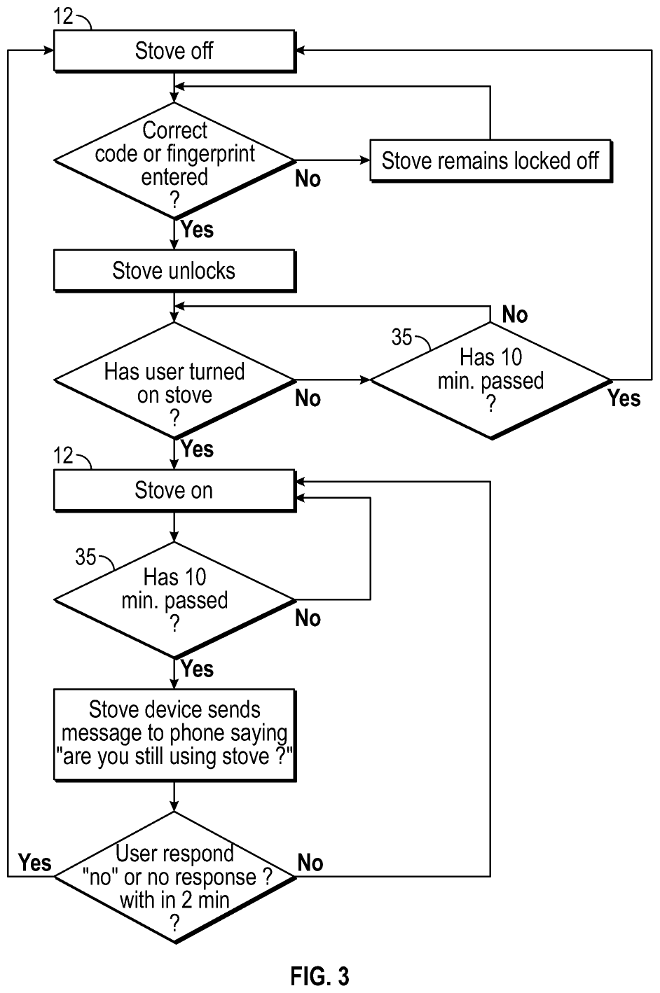

In use, each of the burner controls 14 in the stove 12 is normally actuated in the disabled condition to inhibit the stove 12 from being employed for cooking. In this way a person with dementia, for example, cannot employ the stove 12 and potentially cause a fire. The authorized user either scans their fingerprint on the biometric scanner 18 or the authorized user enters the predetermined numeric code in the keypad 20 to enable the burner controls 14 on the stove 12. In this way the stove 12 can be employed for cooking under the supervision of the authorized user. Additionally, the user can employ the personal electronic device 36 to remotely enable or disable the burner controls 14. Furthermore, as is most clearly shown in FIG. 3, the control application 40 queries the authorized user if they are still intending to employ the stove when the electronic timer completes the countdown. Additionally, each of the burner controls 14 returns to being actuated into the disabled condition once the burner controls 14 are turned off. In this way none of the burner controls 14 can be turned back on without the authorized user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A remote stove lock assembly for remotely disabling a stove thereby inhibiting a person with dementia from employing the stove, said assembly comprising:
a stove having a plurality of burner controls;
a control unit being attached to said stove, said control unit being in communication with each of said burner controls, said control unit having a biometric scanner thereby facilitating said biometric scanner to scan an authorized user's fingerprint, said control unit enabling each of said burner controls when said biometric scanner scans the authorized user's fingerprint thereby facilitating said stove to be employed for cooking, said control unit disabling each of said burner controls until said biometric scanner scans the authorized user's fingerprint thereby inhibiting said stove from being employed for cooking wherein said control unit is configured to inhibit a person with dementia from operating said stove, said control unit having a keypad for facilitating a predetermined numeric code to be entered into said control unit, said control unit enabling each of said burner controls when said predetermined numeric code is entered into said control unit; and
a personal electronic device being carried by the authorized user, said personal electronic device being in remote communication with said control unit, said control unit enabling each of said burner controls when said personal electronic device broadcasts an actuate command to said control unit wherein said personal electronic device is configured to facilitate the authorized user to remotely enable or disable said stove.

2. The assembly according to claim 1, wherein said control unit comprises:
a housing being positioned on a front face of said stove, said housing having a front surface being exposed with respect to said front face, said biometric scanner being positioned on said front surface, said keypad being positioned on said front surface, said keypad comprising a plurality of alphanumeric keys; and
a control circuit being integrated into said housing, said control circuit being electrically coupled to each of said burner controls, each of said burner controls being normally actuated into a disabled condition such that said stove is inhibited from being employed for cooking, said control circuit receiving an actuate input, each of said burner controls being actuated into an enabled condition when said control circuit receives said actuate input thereby facilitating said stove to be employed for cooking.

3. The assembly according to claim 2, wherein said control circuit is electrically coupled to said biometric scanner, said control circuit receiving said actuate input when said biometric scanner scans the authorized user's fingerprint.

4. The assembly according to claim 2, wherein said control circuit is electrically coupled to said keypad, said control circuit receiving said actuate input when said predetermined numeric code is entered into said keypad, said control circuit being electrically coupled to a power source comprising a power supply of said stove.

5. The assembly according to claim 2, further comprising a transceiver being integrated into said housing, said transceiver being electrically coupled to said control circuit.

6. The assembly according to claim 5, wherein:
said personal electronic device includes a transceiver, said transceiver in said personal electronic device being in wireless communication with said transceiver of said control unit; and
said personal electronic device stores a control application, said control application actuating said transceiver in said personal electronic device to broadcast said actuate command to said transceiver in said control unit when said control application is manipulated by the authorized user to perform an actuation subroutine, said control application actuating said transceiver in said personal electronic device to broadcast a de-actuate command to said transceiver in said control unit when said control application is manipulated by the authorized user to perform a de-actuation subroutine, each of said burner controls being actuated into said disabled condition when said transceiver in said control unit receives said de-actuate command.

7. A remote stove lock assembly for remotely disabling a stove thereby inhibiting a person with dementia from employing the stove, said assembly comprising:
a stove having a plurality of burner controls;
a control unit being attached to said stove, said control unit being in communication with each of said burner controls, said control unit having a biometric scanner thereby facilitating said biometric scanner to scan an authorized user's fingerprint, said control unit enabling each of said burner controls when said biometric scanner scans the authorized user's fingerprint thereby facilitating said stove to be employed for cooking, said control unit disabling each of said burner controls until said biometric scanner scans the authorized user's fingerprint thereby inhibiting said stove from being employed for cooking wherein said control unit is configured to inhibit a person with dementia from operating said stove, said control unit having a keypad for facilitating a predetermined numeric code to be entered into said control unit, said control unit enabling each of said burner controls when said predetermined numeric code is entered into said control unit, said control unit comprising:
a housing being positioned on a front face of said stove, said housing having a front surface being exposed with respect to said front face, said biometric scanner being positioned on said front surface, said keypad being positioned on said front surface, said keypad comprising a plurality of alphanumeric keys;
a control circuit being integrated into said housing, said control circuit being electrically coupled to each of said burner controls, each of said burner controls being normally actuated into a disabled condition such that said stove is inhibited from being employed for cooking, said control circuit receiving an actuate input, each of said burner controls being actuated into an enabled condition when said control circuit receives said actuate input thereby facilitating said stove to be employed for cooking, said control circuit being electrically coupled to said biometric scanner, said control circuit being electrically coupled to said keypad, said control circuit receiving said actuate input when said biometric scanner scans the authorized user's fingerprint, said control circuit receiving said actuate input when said predetermined numeric code is entered into said keypad, said control circuit being electrically coupled to a power source comprising a power supply of said stove; and
a transceiver being integrated into said housing, said transceiver being electrically coupled to said control circuit; and
a personal electronic device being carried by the authorized user, said personal electronic device being in remote communication with said control unit, said control unit enabling each of said burner controls when said personal electronic device broadcasts an actuate command to said control unit wherein said personal electronic device is configured to facilitate the authorized user to remotely enable or disable said stove, said personal electronic device including a transceiver, said transceiver in said personal electronic device being in wireless communication with said transceiver of said control unit, said personal electronic device storing a control application, said control application actuating said transceiver in said personal electronic device to broadcast said actuate command to said transceiver in said control unit when said control application is manipulated by the authorized user to perform an actuation subroutine, said control application actuating said transceiver in said personal electronic device to broadcast a de-actuate command to said transceiver in said control unit when said control application is manipulated by the authorized user to perform a de-actuation subroutine, each of said burner controls being actuated into said disabled condition when said transceiver in said control unit receives said de-actuate command.
